(19) United States
(12) Patent Application Publication
(10) Pub. No.: US 2004/0094739 A1
(43) Pub. Date: May 20, 2004

(54) Quick coupler for removably joining two pipes

(75) Inventors: Jean-Jacques Lacroix, Lovagny (FR); Olivier Pastore, Faverges (FR)

Correspondence Address: DOWELL & DOWELL PC, SUITE 309, 1215 JEFFERSON DAVIS HIGHWAY, ARLINGTON, VA, 22202

(73) Assignee: STAUBLI FAVERGES, Faverges (FR)

(21) Appl. No.: 10/712,049

(22) Filed: Nov. 14, 2003

(30) Foreign Application Priority Data
Nov. 19, 2002 (FR) 0214466
Sep. 16, 2003 (FR) 0310854

(51) Int. Cl. F16K 51/00

(52) U.S. Cl. 251/149.1

(57) ABSTRACT

The coupler according to the invention comprises a male element adapted to be fitted in a female element and maintained in this position by a latch forming stop and opposing a movement of withdrawal thereof.

The body of the female element comprises a principal part in which is axially immobilized a secondary part connected to one of the pipes of which the coupler ensures join. Immobilization between these principal and secondary parts occurs by catches borne by the secondary part catching with complementary catches borne by the principal part.

### FIELD OF THE INVENTION

The present invention relates to a quick coupler for the removable join of pipes conveying fluid under pressure.

### BACKGROUND OF THE INVENTION

Patent FR-2 514 855 discloses a quick coupler which comprises two elements, male and female, adapted to fit axially, provoking the opening of a closure valve mounted in the body of the female element, this body being equipped with a loaded latch or button, mounted to slide in this body and pierced with a central opening for fit of the male element. The female element is constituted by two tubular pieces assembled on each other by screwing, which requires effecting a threading and a tapping on these pieces and that the operator who assembles this element take particular care, otherwise the thread and/or the tapping risk being distorted.

The same limitations are found in the couplers known from French Patent 1 724 710 and U.S. Pat. No. 5,806,832.

It is a more particular object of the present invention to overcome these drawbacks by proposing a coupler between pipes conveying fluids under pressure, of which the female element is economical and simple to assemble.

### SUMMARY OF THE INVENTION

To that end, the invention has for its first object a quick coupler for the removable join of two pipes through which a fluid under pressure passes, this coupler comprising two elements, male and female, adapted to fit axially in each other, the body of the female element comprising a principal part in which is axially immobilized a secondary part connected to one of the pipes, characterized in that immobilization between the principal and secondary parts occurs by at least one catch borne by the secondary part catching with at least one complementary catch borne by the principal part.

Thanks to the invention, the assembly of the female element is economical, simple, reliable and robust, and a possible misalignment of the principal and secondary parts during assembly induces few risks of deteriorating these parts to the point of preventing their connection, while such might be the case with screwed elements.

According to advantageous but non-obligatory aspects of the invention, the coupler incorporates one or more of the following characteristics:

Immobilization between the principal and secondary parts occurs by several catches borne by the secondary part catching with complementary catches borne by the principal part.

The catch or catches borne by the secondary part are formed on its outer radial surface.

The complementary catch or catches borne by the principal part are formed on the inner radial surface of a bore for receiving the secondary part.

The secondary part is immobilized axially with respect to the principal part with the possibility of rotation with respect thereto about a central axis of the female element. This makes it possible to adjust the relative angular position of these parts, particularly when the secondary part is fixed in order to facilitate access to a button for controlling a latch.

A mobile closure valve is mounted in the secondary part. The latter advantageously defines a groove for receiving an O-ring for seal of this valve.

An O-ring, intended to cooperate with the male element, is mounted in the secondary part, this ensuring seal when the coupler is in connected configuration.

The body of the female element is equipped with a latch loaded by elastic means, mounted to slide in a housing made in the principal part and pierced with an opening for the fit of the male element or of a piece displaced by this element.

### BRIEF DESCRIPTION OF THE DRAWINGS

The invention will be more readily understood on reading the following description of two forms of embodiment of a coupler according to the invention, given solely by way of example and made with reference to the accompanying drawings, in which:

FIG. 1 is a longitudinal section through a coupler according to the invention in a first position where its male and female elements are coupled, the fluid circulating between these two elements.

FIG. 2 is a section similar to FIG. 1, but on a smaller scale, in a second position where the male and female elements are maintained in configuration of decompression of a pipe connected on the male element by pressure on the retaining button or latch; certain elements are truncated in order to render the drawing clearer.

FIG. 3 is a section similar to FIG. 1 but on a smaller scale, a blocking latch being in the same position as in FIG. 2, while a safety member blocks the latch during a phase of reduction of the pressure prevailing in the aforementioned pipe.

FIG. 4 is a section similar to FIG. 2, while the safety member is in rest position, the internal pressure being low, the male element being able to be freely withdrawn from the coupler.

FIG. 5 is a longitudinal section through a coupler in accordance with a second form of embodiment of the invention in a configuration similar to that of FIG. 1.

FIG. 6 is a section similar to FIG. 3 and on the same scale, for the coupler of FIG. 5, and

FIG. 7 is a section similar to FIG. 4 and on the same scale, for the coupler of FIGS. 5 and 6.

### DESCRIPTION OF PREFERRED EMBODIMENTS

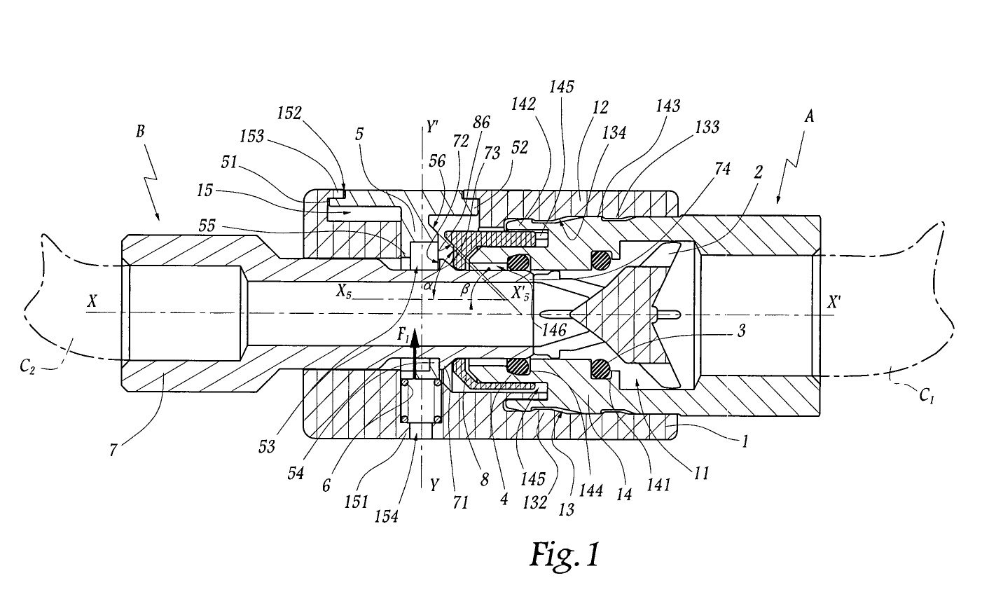

Referring now to the drawings, the coupler shown in FIGS. 1 to 4 comprises a female element A and a male element or connector B connected respectively to an upstream pipe C₁ and to a downstream pipe C₂. The upstream pipe C₁ is itself connected to a source of fluid under pressure (not shown).

The outside shape of the body 1 of the female element is substantially cylindrical and circular, centred on an axis X-X′ which is also the longitudinal axis of a conduit 11 inside the body 1 and in which is arranged a valve 2 mobile along axis X-X′. The body 1 is in two parts and comprises a principal part 12 forming a bore 13 in which is immobilized a secondary part 14 fast with the pipe C₁. In practice, the valve 2 is mounted in part 14 which defines a groove 141 for receiving an O-ring 3 for seal of the valve 2.

The outer radial surface of part 14 is provided with catches 142 and 143 intended to cooperate with catches 132 and 133 provided on the inner radial surface 134 of the bore 13. Cooperation of the notches 132, 133, 142, 143 allows a firm immobilization of part 14 in the bore 13 of part 12, these parts advantageously being made of metal.

The immobilization obtained by the cooperation of notches 132, 133, 142, 143 is essentially axial, in that it opposes a movement of extraction of part 14 out of the bore 13, in a direction parallel to axis X-X′.

Part 14 defines a second groove 144 for receiving an O-ring 4 intended to cooperate with the outer radial surface 75 of the body 7 of the male element B.

The body 1 is also provided with a housing 15 extending substantially in the direction of an axis Y-Y′ perpendicular to axis X-X′, i.e. radial. The housing 15 is made in part 12 of the body 11. Inside the housing 15 is slidably mounted a latch 5 on which a spring 6 exerts an elastic effort F₁ directed opposite the bottom 151 of the housing 15, i.e. in the direction of its opening 152. The movement of the latch 5 under the effect of the effort F₁ is limited by two projections 51 and 52 coming into abutment against the edge 153 of the opening 152. The bottom 151 of the housing 15 is provided with an orifice 154 connecting the housing 15 to the ambient atmosphere.

The housing 15 intersects the conduit 11 which traverses part 12 right through.

The latch 5 is provided with a transverse opening 53 centred on an axis X₅-X′₅ parallel to axis X-X′. The opening 53 is bordered by two teeth 54 and 55 which extend from the circumference of the opening 53 in the direction of axis X₅-X′₅. Tooth 54 is the most remote from the opening 111 of the conduit 11 on the male connector B side, while tooth 55 is nearest this opening.

In the configuration of FIG. 1, and in the absence of effort exerted on the latch 5 by a user, this latch is subjected to the action of the spring 6, with the result that its tooth 54 is inserted to the rear of a shoulder 72 formed by a flange 71 provided on the periphery of the metal body 7 of the male connector B. The flange 71 is also provided with an inclined ramp 73 which is truncated and convergent in the direction of the front end 74 of the body 7.

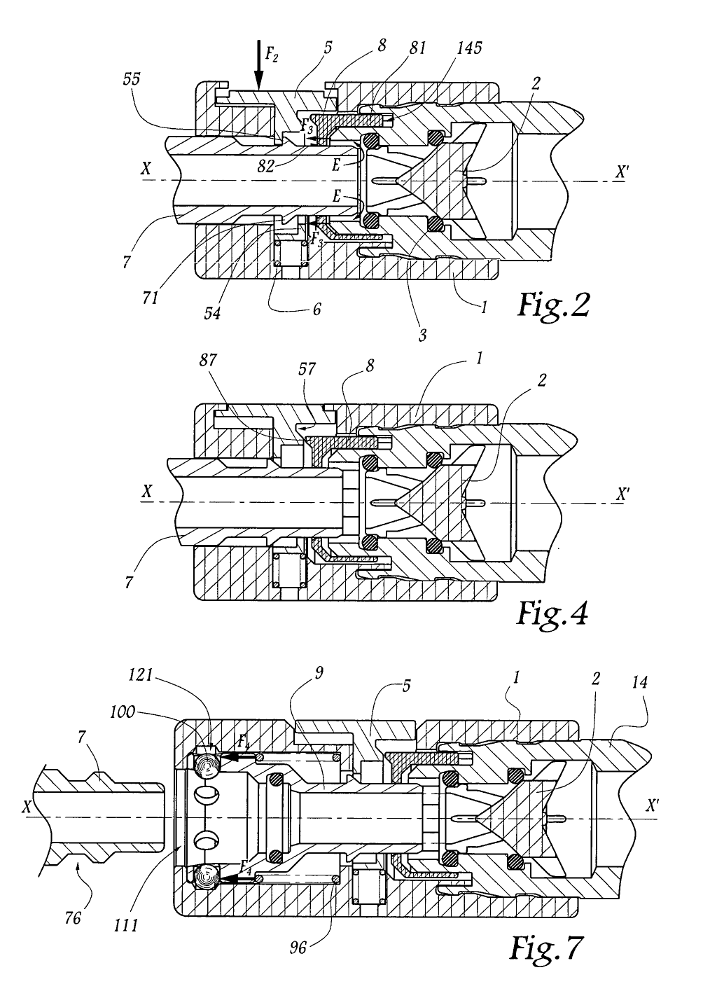

When the coupler is to be unlocked, an effort F₂ is exerted on the latch 5, this having the effect of retracting the tooth 54 from the path of withdrawal of the flange 71, as shown in FIG. 2. Under the effect of the pressure prevailing in the pipe C₂, the valve is pushed towards the O-ring 3. The connector 7 moves along axis X-X′ in the same direction and the flange 71 comes into abutment against the tooth 55 of the latch or button 5.

The shape of the catches 132, 133, 142, 143 is advantageously provided so that an angular movement of parts 12 and 14 is possible about axis X-X′. This makes it possible to orient these parts angularly with respect to each other, which proves to be very practical, particularly when part 14 is fixed, for example screwed on a support. In that case, it is, in effect, possible to cause part 12 to rotate about axis X-X′ in order to orient the housing 15 in a radial direction such that access to the latch 5 is easy, in particular for application of the effort F₂. Accessibility and manoeuvrability of the coupler are improved thereby.

A piston 8 is in place in the conduit 11 of the body 1, this piston being able to slide in the direction of axis X-X′. The piston 8 comprises a skirt 81 engaged in a housing 145 formed in part 14 and in a part 112 of the conduit 11 defined between parts 12 and 14 of the body 1. The cooperation of the skirt 81 and of the housing 145 makes it possible to guide the piston 8 in translation.

This piston 8 is provided with a central opening 82 allowing the passage of the connector 7, with the result that the piston 8 is disposed around the connector 7, inside the conduit 11 and in a part of this conduit defined by parts 12 and 14 in the configurations of FIGS. 1 to 4. The fact that the body 1 is in two parts allows the piston to be placed in position and imprisoned in the conduit 11.

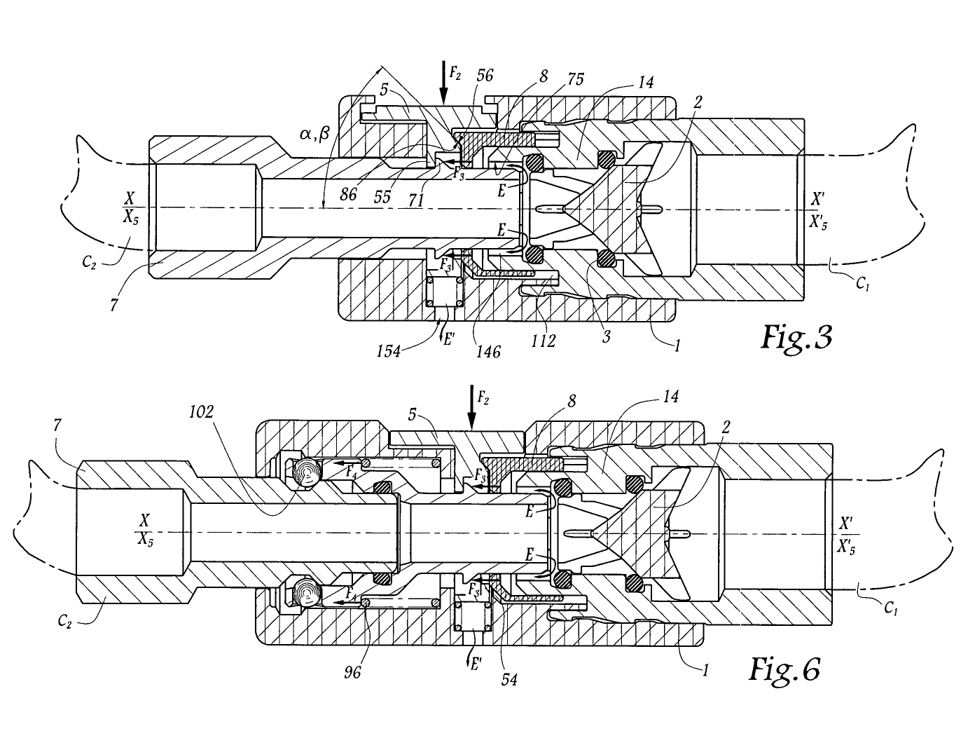

The opening 82 has a shape and dimensions close to the outer transverse dimensions of the front part of the connector 7. In this way, from the configuration of FIG. 2, the fluid under pressure located in pipe C₂ flows, as represented by arrows E, around the connector 7, in a passage 146 formed between the inner radial surface of part 14 and the outer radial surface 75 of the connector 7, to such a point that the pressure of the fluid present in the pipe C₂ and in the connector 7 exerts on the piston 8 an effort F₃ which pushes the piston 8 in the direction of the latch 5, in order to attain the position of FIG. 3.

The latch 5 is provided with a surface 56 which is in the form of a frusto-conical sector, centred on axis X₅-X′₅ and convergent in the direction of the valve 2, i.e. upstream of the coupler.

As for the piston 8, it is provided with a surface 86 likewise in the form of a frusto-conical sector, centred on axis X-X′ and convergent in the direction of upstream of the coupler. α and β respectively denote the semi-vertex angles of these surfaces 56 and 86. Angles α and β have the same value, which is of the order of 45°.

The surfaces 56 and 86 might have a geometry other than a frusto-conical sector. It might be question of parts of complementary rectilinear teeth orthogonal to axis X-X′ and provided with an oblique face with respect thereto.

The displacement of the latch 5 under the effect of the effort F₂ has the effect of aligning the axis X₅-X′₅ on axis X-X′, with the result that, under the effect of the effort F₃, the surface 86 of the piston 8 comes into abutment against the surface 56 of the latch 5, this immobilizing this latch in the position of FIG. 3 where it prevents the release of the connector 7 as long as the effort F₃, generated by the pressure prevailing inside the pipe C₂ and the connector 7, is greater than a predetermined value which depends on the effort F₁, i.e. on the stiffness constant of the spring 6, and this independently of the effort F₂ which may in that case be exerted, or not, on the latch or button 5.

In practice, leakages occur at the join between the edge of the opening 82 and the surface 75 and around the skirt 81, such leakages resulting in a flow E′ of gas under pressure towards the outside of the housing 15, through the orifice 154. In this way, the pressure in the pipe C, and in the connector 7 decreases progressively, in the same way as the effort F₃ which may in that case be overcome by the effort F₁ exerted by the spring 6, this then causing slide of the surfaces 56 and 86 on each other, the return of the piston 8 in the direction of the bottom of the housing 145 and the release of the latch 5 which then attains the position of FIG. 4 where its tooth 55 no longer opposes the withdrawal of the male element B with respect to the female element A.

The surface 86 is formed by a nose 87 of the piston 8 which may engage in a recess 57 provided to that end on the latch 5.

The movements of translation of the piston 8 parallel to axis X-X′ result from the variations in pressure in the conduit 11 of the reaction effort transmitted between the surfaces 56 and 86, without it being necessary to use a return spring, this improving reliability of the coupler and increasing its economic performances.

The upstream-convergent nature of the surfaces 56 and 86 allows the piston to return towards the housing 145 under the effect of the effort F₁ when the latter overcomes effort F₃.

The inclined surface 56 of the latch 5 has such a slope and orientation that they facilitate the disengagement of the nose 87 borne by the piston 8 during the movement of the latch 5. Depending on the geometry and inclination of the surfaces 56 and 86, disengagement occurs more or less easily as a function of the remaining residual pressure, this for the same spring 13. The coupler 1 may thus be “calibrated” in order that uncoupling is possible from a given residual internal pressure.

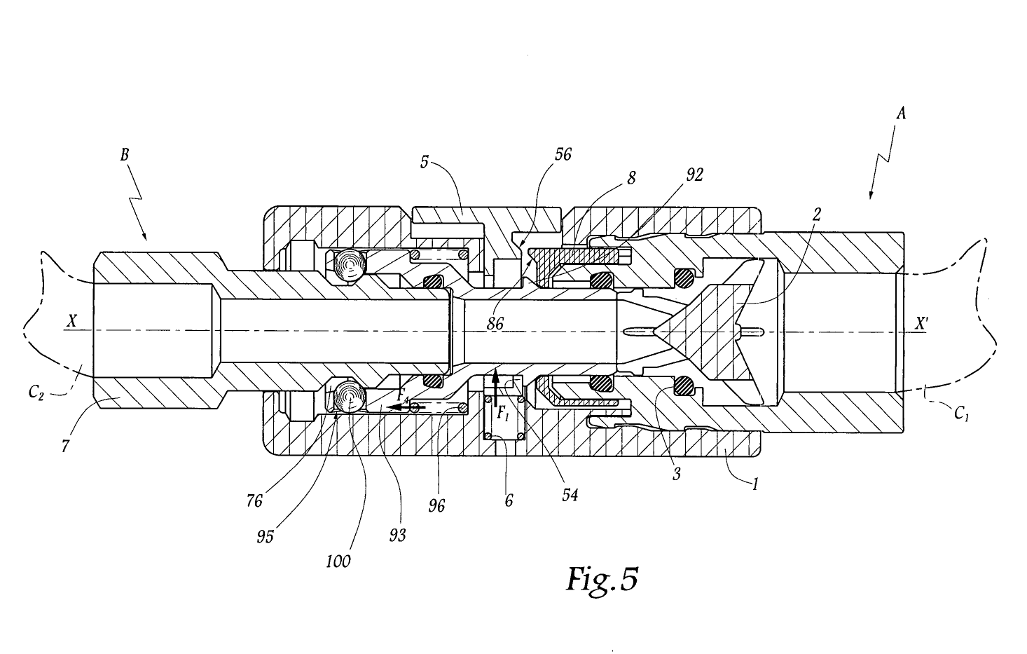

In the second form of embodiment of the invention shown in FIGS. 5 to 7, the elements similar to those of the first embodiment bear identical references. The female (A) and male (B) elements of this coupler are intended to fit axially in each other and there are provided in the body 1 of the female element A a latch 5 and a piston 8 similar to those of the first embodiment, these members being provided with respective surfaces 56 and 86 for blocking in configuration of purge or communication with the air of the inner volume of the downstream pipe C₂ and of the male connector 7. A spring 6 exerts on the latch 5 an effort F₂ directed upwardly in FIGS. 5 to 7.

An intermediate piece 9 is housed in the principal conduit of the body 1 of the female element and comprises a cylindrical part 91 provided with a flange 92, this part 91 having substantially the same outer geometry as the front part of the body 7 of the first embodiment. The piece 9 also comprises a part 93 of larger diameter than part 91 and defining a housing for receiving a male connector 7 of the type described in Patent FR-2-724 710.

Part 93 is provided, on its circumference, with a plurality of housings 95 for receiving balls 100 capable of being engaged in a peripheral groove 76 of the body 7 which they then retain in position in the part 93. A spring 96 exerts on the piece 9 an effort F₄ directed towards the opening 111 of the conduit 11.

Functioning is as follows:

In the configuration of FIG. 5, the tooth 54 of the latch 5 maintains the piece 9 in configuration of circulation of fluid through the coupler, the effort F₄ exerted by the spring 96 in that case being overcome and the balls 100 then being opposite a cylindrical part with rectilinear generatrix 115 of the conduit 11, with the result that they are engaged in the groove 76 and retain the connector 7 captive.

When the coupler is to be unlocked, an effort F₂ is exerted on the latch 5, which has the effect of disengaging the tooth 54 with respect to the flange 92 which then comes into abutment against the second tooth 55 of the latch 5. As previously, under the effect of the flow E of the fluid under pressure, the piston 8 is displaced by the effort F₃ in the direction of the latch 5, to such a point that its surface 86 comes into contact with the corresponding surface 56 of the latch 5. The effort F₄ due to the spring 96 slightly displaces the piece 9 inside the conduit 11, the balls 100 remaining engaged in the groove 76 and thus retaining the connector 7 captive.

When the pressure in the pipe C₂ and in the pieces 7 and 9 has decreased due to the organized leakages represented by the flow E′, the piston 8 releases the latch 5 which moves, under the effect of the effort F₁ due to the spring 6, towards the position of FIG. 7 where the flange 92 is released from the tooth 55, this having the effect of allowing the spring 96 to push the piece 9 in the direction of the opening 111 of the conduit 11. The balls 100 are thus brought opposite an inner radial groove 121 made in the piece 12, which makes it possible to extract the balls 100 from the groove 76 of the body 7 of the connector B and thus to release this connector.

According to a variant of the invention (not shown), one sole catch may be provided on the secondary part 14, while a corresponding single catch is provided on the principal part 12 for catching of the parts constituting the body of the female element.

According to another variant, likewise not shown, the catch or catches may be provided on a female zone of the secondary part 14, while the complementary catch or catches are provided on a male zone of the principal part 12.

Whatever the form of embodiment in question, the elements constituting the coupler are advantageously made of a metallic material or a plastics material resisting the pressures of the fluid to be conveyed, and chosen as a function of the nature of the fluid.

What is claimed is:

1. Quick coupler for the removable join of two pipes through which a fluid under pressure passes, said coupler comprising two elements, male and female, adapted to fit axially in each other, the body of said female element comprising a principal part in which is axially immobilized a secondary part connected to one of the pipes, wherein immobilization between said principal and secondary parts occurs by at least one catch borne by said secondary part catching with at least one complementary catch borne by said principal part.

2. Quick coupler of claim 1, wherein immobilization between said principal and secondary parts occurs by several catches borne by said secondary part catching with complementary catches borne by said principal part.

3. The quick coupler of claim 1, wherein said catch or catches borne by said secondary part are formed on its outer radial surface.

4. The quick coupler of claim 1, wherein said complementary catch or catches borne by said principal part are formed on the inner radial surface of a bore for receiving said secondary part.

5. The quick coupler of claim 1, wherein said secondary part is immobilized axially with respect to said principal part with the possibility of rotation with respect thereto about a central axis of said female element.

6. The quick coupler of claim 1, wherein a mobile closure valve is mounted in said secondary part.

7. The quick coupler of claim 6, wherein said secondary part defines a groove for receiving an O-ring for seal of said valve.

8. The quick coupler of claim 1, wherein an O-ring, intended to cooperate with the male element, is mounted in said secondary part.

9. The quick coupler of claim 8, wherein said secondary part defines a groove for receiving said seal.

10. The quick coupler of claim 1, wherein the body of the female element is equipped with a latch loaded by elastic means, mounted to slide in a housing made in said principal part and pierced with an opening for the fit of said male element or of a piece displaced by said male element.
